(19) United States
(12) Patent Application Publication
(10) Pub. No.: US 2013/0246455 A1
(43) Pub. Date: Sep. 19, 2013

(54) DOCUMENT MANAGEMENT APPARATUS, NON-TRANSITORY COMPUTER READABLE MEDIUM, AND DOCUMENT MANAGEMENT METHOD

(71) Applicant: Toru OTSUKA, Kanagawa (JP)

(72) Inventor: Toru OTSUKA, Kanagawa (JP)

(73) Assignee: FUJI XEROX CO., LTD., Tokyo (JP)

(21) Appl. No.: 13/610,295

(22) Filed: Sep. 11, 2012

(30) Foreign Application Priority Data
Mar. 19, 2012 (JP) 2012-062131

(51) Int. Cl. G06F 17/30

(52) U.S. Cl. 707/769; 707/E17.014

(57) ABSTRACT

A document management apparatus includes a search unit that searches for documents using a search character string which is input as a search condition by a search execution user, a secret condition success determining unit that determines whether or not the search condition satisfies a predetermined secret condition, and a warning unit that outputs warning information when the search condition satisfies the secret condition and the search execution user does not have access authority for the searched document.

### CROSS-REFERENCE TO RELATED APPLICATIONS

This application is based on and claims priority under 35 USC 119 from Japanese Patent Application No. 2012-062131 filed Mar. 19, 2012.

### BACKGROUND

### Technical Field

The present invention relates to a document management apparatus, a non-transitory computer readable medium, and a document management method.

### SUMMARY

According to an aspect of the invention, there is provided a document management apparatus including a search unit that searches for documents using a search character string which is input as a search condition by a search execution user; a secret condition success determining unit that determines whether or not the search condition satisfies a predetermined secret condition; and a warning unit that outputs warning information when the search condition satisfies the secret condition and the search execution user does not have access authority for the searched document.

### BRIEF DESCRIPTION OF THE DRAWINGS

Exemplary embodiments of the present invention will be described in detail based on the following figures, wherein:

FIG. 1 is a diagram exemplifying a configuration of a document management apparatus according to a first embodiment;

FIG. 2 is a diagram exemplifying information held in a secret keyword holding unit;

FIG. 3 is a flowchart exemplifying a process performed by the document management apparatus;

FIG. 4 is a diagram exemplifying a configuration of a document management apparatus according to a modified example 1;

FIG. 5 is a diagram exemplifying a configuration of a document management apparatus according to a modified example 2;

FIG. 6 is a diagram exemplifying a configuration of a document management apparatus according to a second embodiment;

FIG. 7 is a flowchart exemplifying a process performed by the document management apparatus;

FIG. 8 is a diagram exemplifying a configuration of a document management apparatus according to a third embodiment; and

FIG. 9 is a flowchart exemplifying a process performed by the document management apparatus.

### DETAILED DESCRIPTION

Hereinafter, embodiments of the present invention will be described in detail with reference to the drawings.

### First Embodiment

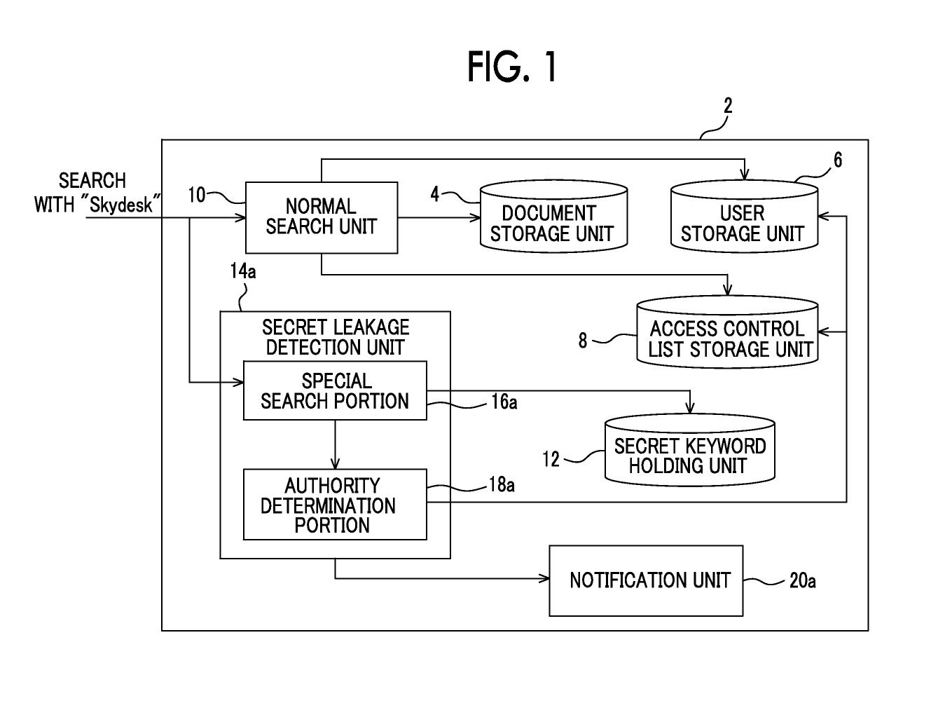

FIG. 1 is a diagram exemplifying a configuration of a document management apparatus 2 according to the first embodiment of the present invention. The document management apparatus 2 is, for example, a personal computer, a server computer, and the like, and includes a microprocessor, a main storage device, a hard disk, a display, a network interface, and the like. The document management apparatus 2 is connected to a public network via the network interface. The main storage device stores various programs. These programs are read from a computer readable information storage medium and are stored in the main storage device. Alternately, the programs are received from a program holding device via the public network and are stored in the main storage device.

In the document management apparatus 2, the programs stored in the main storage device are executed by the microprocessor, thereby realizing various functions such as a document storage unit 4, a user storage unit 6, an access control list storage unit 8, a normal search unit 10, a secret keyword holding unit 12, a secret leakage detection unit 14a, and a notification unit 20a. The document storage unit 4, the user storage unit 6, the access control list storage unit 8, and the secret keyword holding unit 12 are realized with the hard disk. In addition, the normal search unit 10, the secret leakage detection unit 14a, and the notification unit 20a are realized by the microprocessor. Further, the secret leakage detection unit 14a includes a special search portion 16a and an authority determination portion 18a.

The document storage unit 4 stores plural documents created using a document creation application. A unique identifier (hereinafter, referred to as a document ID) is assigned to the document. In addition, the user storage unit 6 stores user information regarding each of plural users who use the document management apparatus 2. The user information includes an identifier of a user, a mail address of the user, and the like. In addition, the access control list storage unit 8 stores an access control list (hereinafter, referred to as an ACL) of each of the documents held in the document storage unit 4. The ACL is information obtained by correlating a user ID of a user having any authority for a document with the type of the authority of the user, and indicates which user has which operation authority for a document. In addition, the authority includes, for example, viewing authority, update authority, and the like.

One or plural search keywords are input to the document management apparatus 2 as a search condition by a user (hereinafter, referred to as a login user) which logs in to the document management apparatus 2. When the search condition is input, the normal search unit 10 specifies documents satisfying the search condition among documents for which the login user has viewing authority of documents stored in the document storage unit 4, according to a predetermined search algorithm, by referring to a storage content of each of the document storage unit 4, the user storage unit 6, and the ACL storage unit 8, and displays a list of document IDs of the specified documents as a search result on the display.

However, various causes are expected as causes that secret information is let out, and, for example, there are cases where another person eavesdrops on the conversations between people who know secret. For example, when members of a certain department talk about a top secret project of only the department, there are cases where a passing member of another department stealthily overhears a portion of a content of the top secret project. In order to prevent leakage of the secret due to the above-described cause, it is conceived that a keyword (for example, a product name, or a project name) regarding the top secret project is registered, and whether or not a search of documents is made is monitored. However, in this case, even if a person who knows the top secret project for sufficient reason performs a search, it is mistakenly detected that the secret is let out.

In relation thereto, in order to prevent leakage of secret from being mistakenly detected, the document management apparatus 2 includes the secret keyword holding unit 12 and the secret leakage detection unit 14a. Hereinafter, a description thereof will be made.

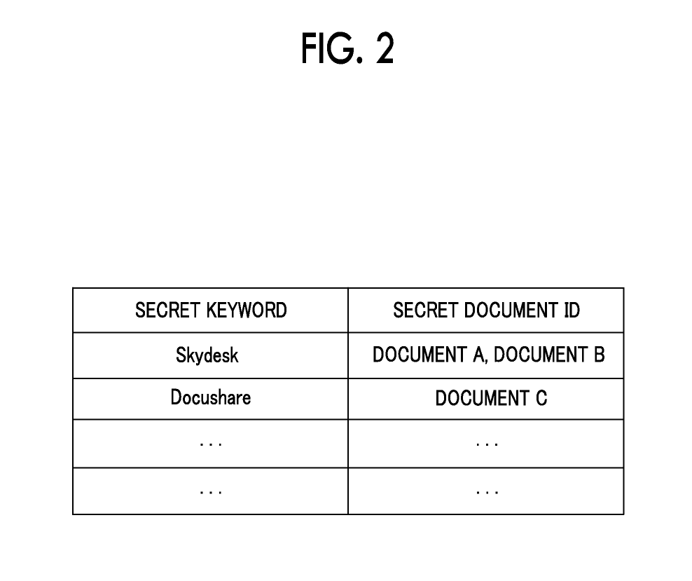

The secret keyword holding unit 12 holds secret keywords registered in advance in correlation with document IDs (hereinafter, referred to as secret document IDs) of one or plural documents related to the secret keywords among the documents stored in the document storage unit 4. In the present exemplary embodiment, information held in the secret keyword holding unit 12 is held in a map form. FIG. 2 exemplifies a storage content of the secret keyword holding unit 12.

Next, a description of the special search portion 16a (search means) and the authority determination portion 18a will be made. The special search portion 16a searches for a document using a search keyword. In the present exemplary embodiment, in a case where the search keyword is held in the secret keyword holding unit 12 as a secret keyword, the special search portion 16a searches for a document among documents indicated by secret document IDs held in the secret keyword holding unit 12. Specifically, the special search portion 16a determines whether or not the search keyword is held in the secret keyword holding unit 12 as a secret keyword, and, if the search keyword is held in the secret keyword holding unit 12 as a secret keyword, specifies a secret document ID correlated with the search keyword, and uses the specified secret document ID as a search result.

In addition, in a case where the search keyword is held in the secret keyword holding unit 12 as a secret keyword, the authority determination portion 18a determines whether or not a login user has viewing authority of the document by referring to an ACL of the document indicated by the secret document ID of the search result.

In addition, if the login user does not have viewing authority of the document by referring to an ACL of the document indicated by the secret document ID of the search result, the notification unit 20a (warning means) performs a warning process in order to notify of a possibility that a secret is let out to a person who may not know the secret. For example, the notification unit 20a transmits a warning electronic mail including a text of notifying that there is a possibility of leakage of the secret.

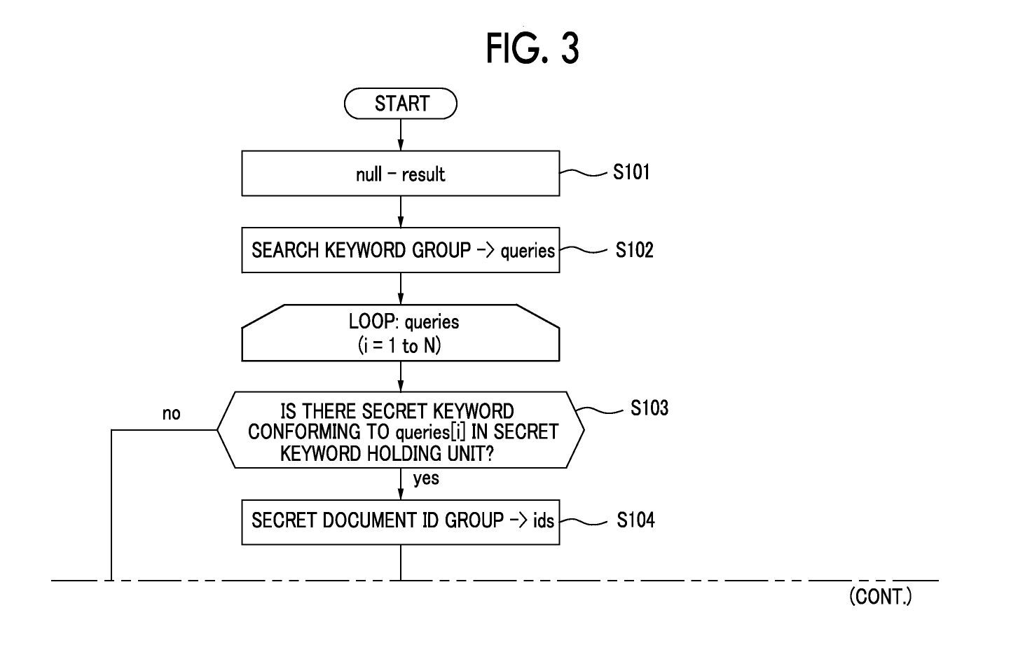

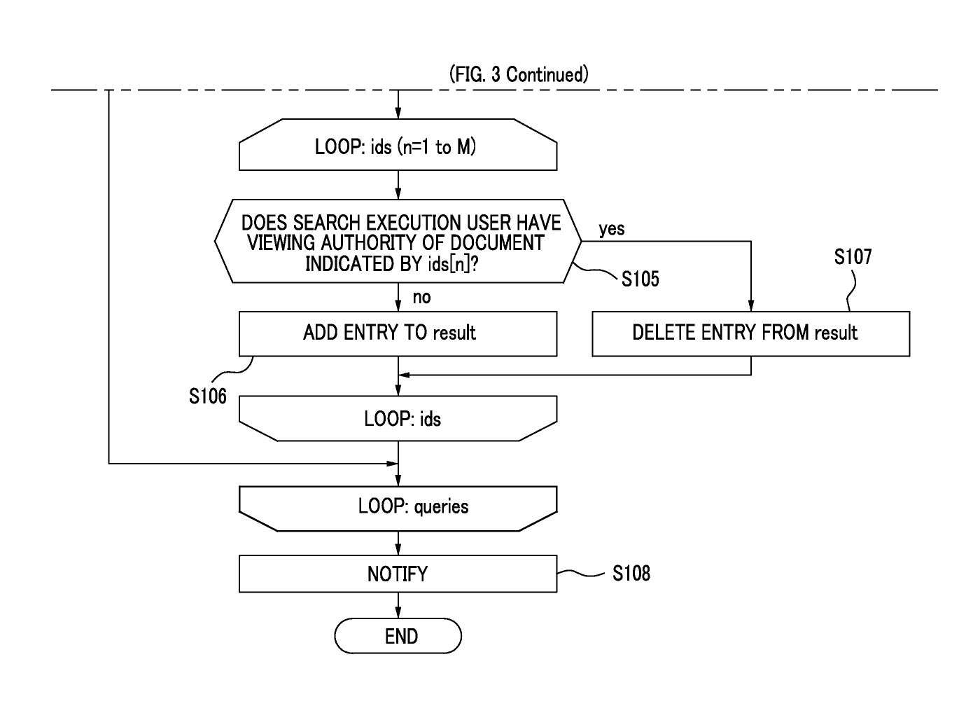

FIG. 3 is a flowchart exemplifying a process performed by the document management apparatus 2. This process is performed when one or plural keywords are input as a search condition by a login user (hereinafter, referred to as a search execution user). In addition, here, description of a process performed by the normal search unit 10 is omitted.

First, the microprocessor initializes result data which is a map holding information necessary to send a notification of leakage of a secret (step S101). The result data will be described later.

In addition, the microprocessor stores a search keyword group including N (where N≧1) search keywords which are input as the search condition in a character string type arrangement queries (step S102). Hereinafter, an i-th (i=1 to N) search keyword is denoted by queries [i].

The microprocessor performs steps S104 to S107 for each search keyword. In other words, the microprocessor (the special search portion 16a) determines whether or not a secret keyword conforming to queries [i] is held in the secret keyword holding unit 12 (S103).

If a secret keyword conforming to queries [i] is held in the secret keyword holding unit 12 (yes in step S103), the microprocessor (the special search portion 16a) stores a secret document ID group including M (where M≧1) secret document IDs correlated with the secret keyword in a character string type arrangement ids (S104). Hereinafter, an n-th (where n=1 to M) secret document ID is denoted by ids [n].

Further, the microprocessor performs steps S105 to S107 for each secret document ID. In other words, the microprocessor (the authority determination portion 18a) determines whether or not the search execution user has viewing authority of the document by referring to an ACL of the document indicated by ids [n] (S105). If the search execution user does not have viewing authority of the document indicated by ids [n] (no in S105), the microprocessor adds an entry to the result data (S106). That is to say, the microprocessor stores the entry having queries [i] as a key in the result data. Here, the entry is data of a map form, holds ids [n] as a key, and holds an email address of a user having view authority of a document indicated by ids [n] as a value. In other words, the microprocessor stores the mail address of the user having viewing authority of the document indicated by ids [n] in the result data in step S106.

On the other hand, in a case where the search execution user has viewing authority of the document indicated by ids [n] (yes in S105), if there is an entry of queries [i] in the result data, the microprocessor deletes the entry (S107). According to steps S105 to S107, if the search execution user does not have viewing authority of any document among documents stored in ids, an entry of queries [i] is not created in the result data. On the other hand, if the search execution user has viewing authority of any one document among the documents stored in ids, an entry of queries [i] is created in the result data. In other words, an email address of a user having viewing authority of a document of which the search execution user does not have viewing authority among the documents stored in ids is stored in the result data.

In this way, when the processes in steps S103 to S107 are completed with regard to all the search keywords stored in queries, the microprocessor (the notification unit 20a) sends a notification of leakage of a secret if there is the entry in the result data (S108). In other words, the microprocessor transmits a warning electronic mail by using the mail address stored in the result data as a destination.

As above, the first embodiment has been described. In addition, in the first embodiment, the term of validity may be set in a secret keyword in advance. In this case, in order to invalidate a secret keyword of which the term of validity has expired, the microprocessor may delete the secret keyword of which the term of validity has expired and a secret document ID correlated therewith from the secret keyword holding unit 12.

In addition, in a case where at least one document is obtained as a search result when documents (public documents) on the Web are searched using a secret keyword as a search condition, the microprocessor may invalidate the secret keyword. Hereinafter, this aspect (hereinafter, referred to as a modified example 1) will be described.

### Modified Example 1

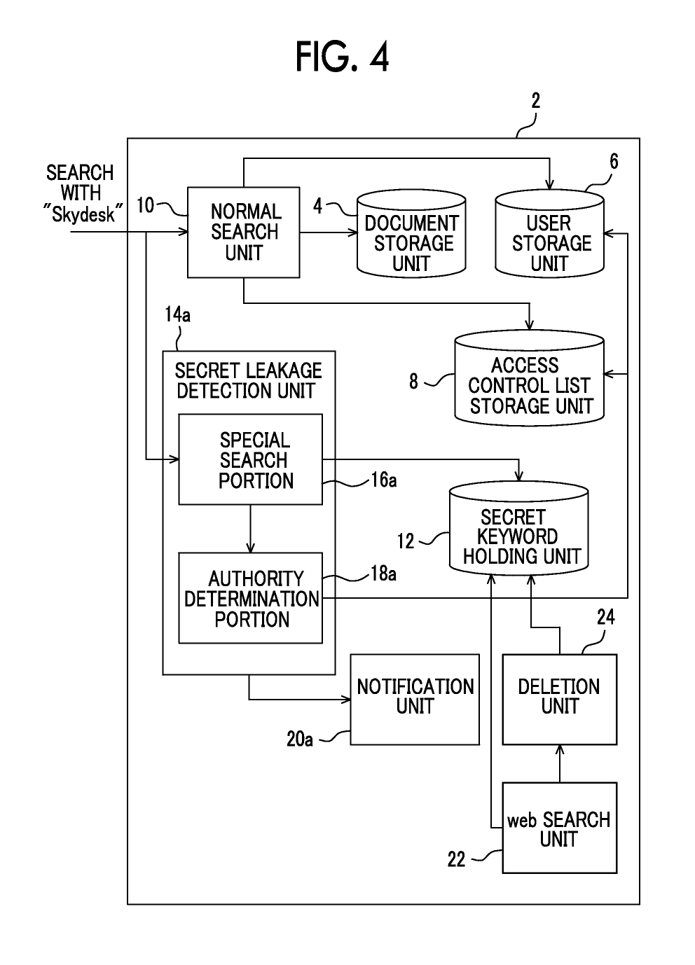

FIG. 4 is a diagram exemplifying a configuration of the document management apparatus 2 in the modified example 1 of the first embodiment. As shown in the same figure, in the modified example 1, the document management apparatus 2 further includes a deletion unit 24 and a Web search unit 22. The deletion unit 24 is realized mainly by the microprocessor. The Web search unit 22 is realized mainly by the microprocessor and the network interface.

The Web search unit 22 performs a search for documents published on the Web by using a secret keyword as a search keyword. For example, the Web search unit 22 inputs the secret keyword to a search engine on the public network and receives a search result. In addition, as a result of the search, if any document is searched, the deletion unit 24 deletes the secret keyword input to the search engine and a secret document ID correlated therewith from the secret keyword holding unit 12. In the modified example 1, the secret keyword is invalidated in the above-described way.

### Modified Example 2

A method in which a secret keyword stored in the secret keyword holding unit 12 is registered by a user may be considered, but a secret keyword may be registered in the following method. Hereinafter, this aspect (referred to as a modified example 2) will be described.

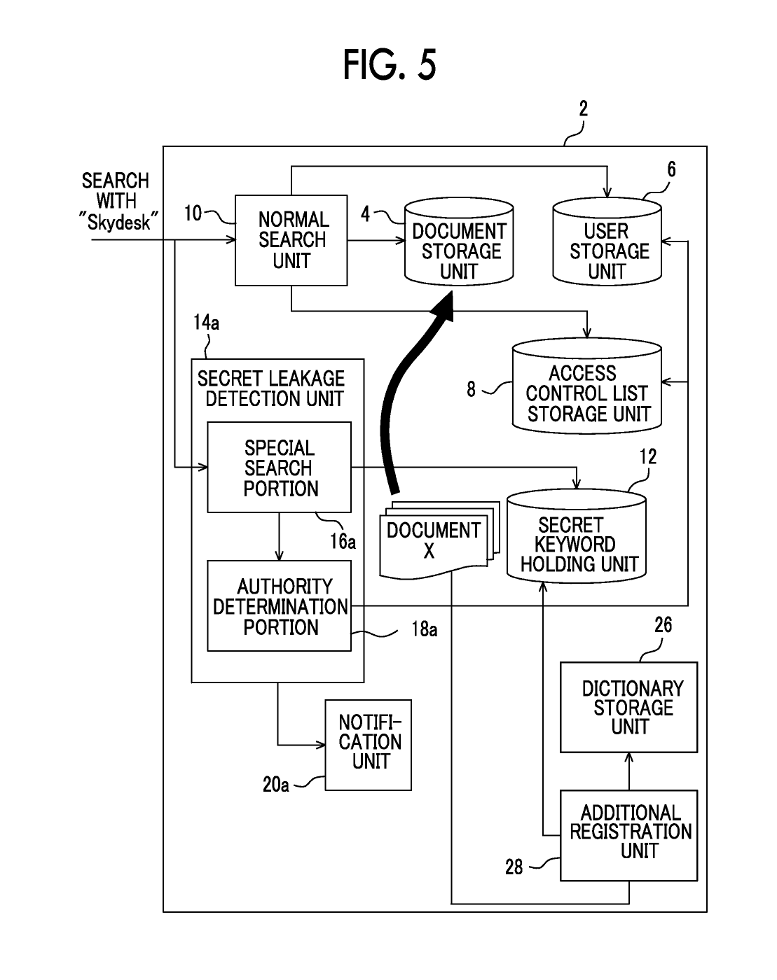

FIG. 5 is a diagram exemplifying a configuration of the document management apparatus 2 in the modified example 2 of the first embodiment. As shown in the same figure, in the modified example 2, the document management apparatus 2 further includes a dictionary storage unit 26 storing a dictionary, and an additional registration unit 28. The dictionary storage unit 26 is realized mainly by the hard disk. In addition, the additional registration unit 28 is realized mainly by the microprocessor.

In the modified example 2, for example, in a case where a new document X is stored in the document storage unit 4, a well-known natural language processing (particularly, morphological analysis) is performed for texts included in the document X, thereby extracting words included in the document X. In addition, it is determined whether or not a significant word which does not exist in a dictionary exists in the document X. Here, the significant word is a word appearing as, for example, an independent word or a nominative word in the document X. In addition, if the significant word (that is, a secret keyword) which does not exist in a dictionary exists in the document X, the additional registration unit 28 stores the significant word which exists in the document X and does not exist in a dictionary in correlation with a document ID (that is, secret document ID) of the document X in the secret keyword holding unit 12. In this way, it is possible to save the trouble when a secret keyword is registered. In addition, since there is a high possibility that a word related to secret information may be a coined word or a new word, and it is considered that the word originally does not exist in a dictionary, detection accuracy of secret leakage is maintained even in this way.

### Second Embodiment

As described above, it is considered that a word related to secret information originally does not exist in a dictionary. Therefore, leakage of a secret may be detected using this fact. Hereinafter, an embodiment (hereinafter, referred to as a second embodiment) of detecting leakage of a secret using this fact will be described.

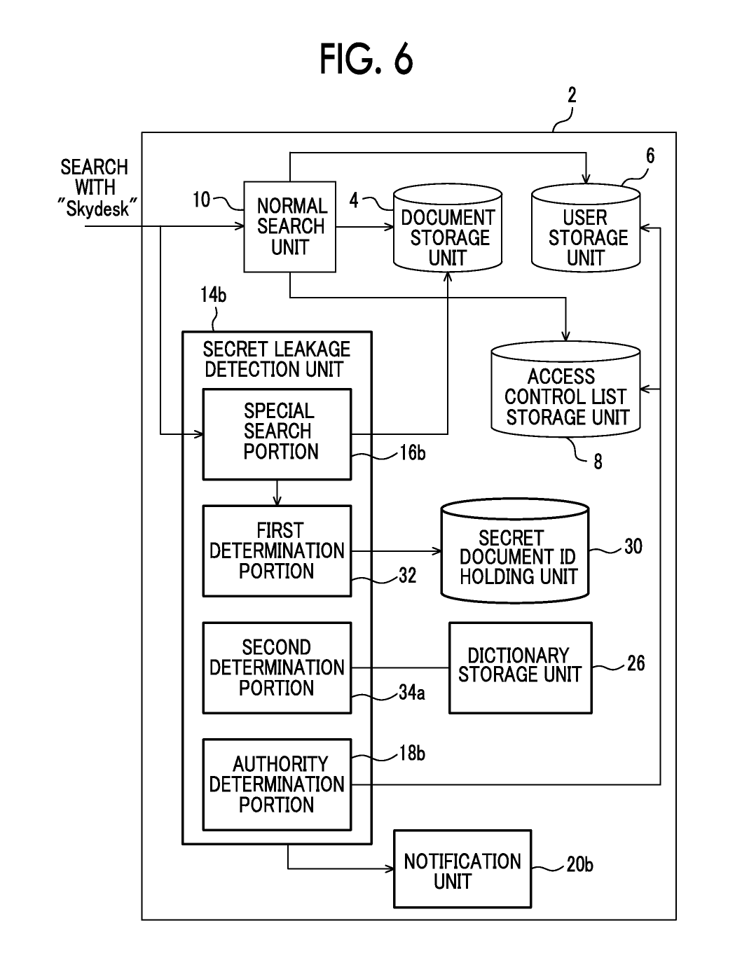

FIG. 6 is a diagram exemplifying a configuration of the document management apparatus 2 according to the second embodiment. In the second embodiment as well, the document management apparatus 2 is realized by a personal computer and a server computer, and includes a document storage unit 4, a user storage unit 6, an ACL storage unit 8, and a normal search unit 10, in the same manner as the first embodiment.

However, in the second embodiment, the document management apparatus 2 includes a secret leakage detection unit 14b instead of the secret leakage detection unit 14a (refer to FIG. 1). The secret leakage detection unit 14b is realized mainly by the microprocessor, and includes a special search portion 16b, a first determination portion 32, a second determination portion 34a, and an authority determination portion 18b. In addition, the document management apparatus 2 includes a notification unit 20b instead of the notification unit 20a (refer to FIG. 1). Further, the document management apparatus 2 includes the dictionary storage unit 26 described in the modified example 2 and a secret document ID holding unit 30 instead of the secret keyword holding unit 12. The secret document ID holding unit 30 is realized mainly with the hard disk, and holds one or plural document IDs (hereinafter, referred to as secret document IDs) of documents which are registered as secret documents in advance. Hereinafter, the secret leakage detection unit 14b and the notification unit 20b will be described.

When a search keyword is input as a search condition, the special search portion 16b searches for documents satisfying the search condition according to the same search algorithm as in the normal search unit 10. However, the special search portion 16b searches for documents satisfying the search condition among the documents stored in the document storage unit 4 in no consideration of viewing authority of a login user.

In addition, the first determination portion 32 determines whether or not a document ID in the search result of the special search portion 16b is held in the secret document ID holding unit 30 as a secret document ID. Further, the second determination portion 34a determines whether or not the search keyword exist in a dictionary. The authority determination portion 18b determines whether or not the login user has viewing authority of the document by referring to an ACL of the document indicated by the document ID in the search result of the special search portion 16b.

In addition, if the document ID in the search result of the special search portion 16b is held in the secret document ID holding unit 30 as a secret document ID, the search keyword does not exist in the dictionary, and the login user does not have viewing authority of the document indicated by the document ID in the search result, the notification unit 20b performs a warning process. For example, the notification unit 20b transmits a warning electronic mail including a text of notifying that there is a possibility of leakage of the secret.

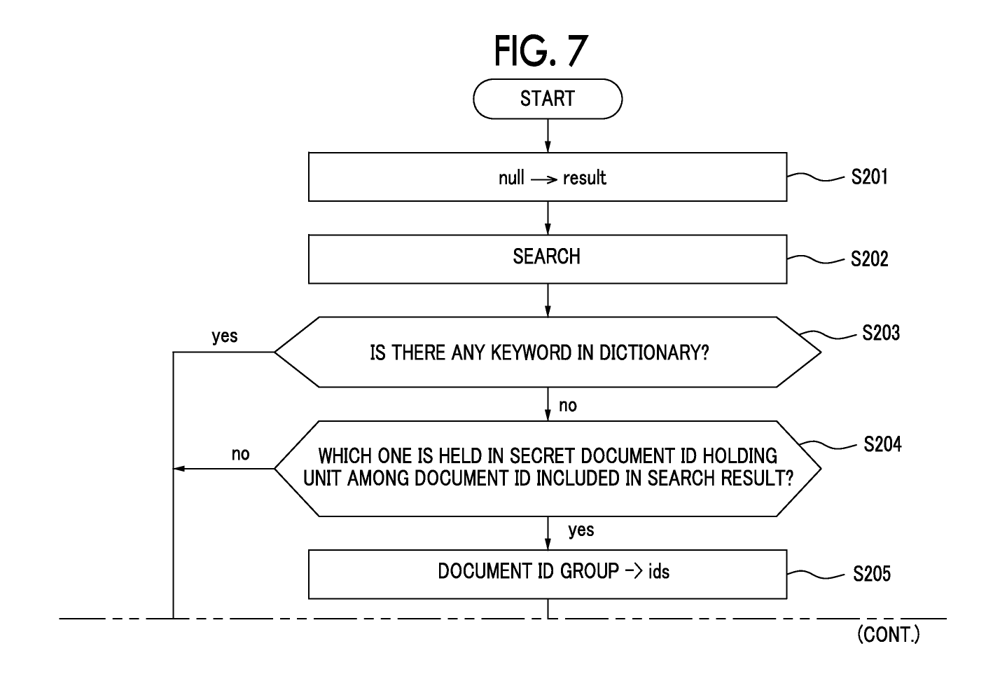

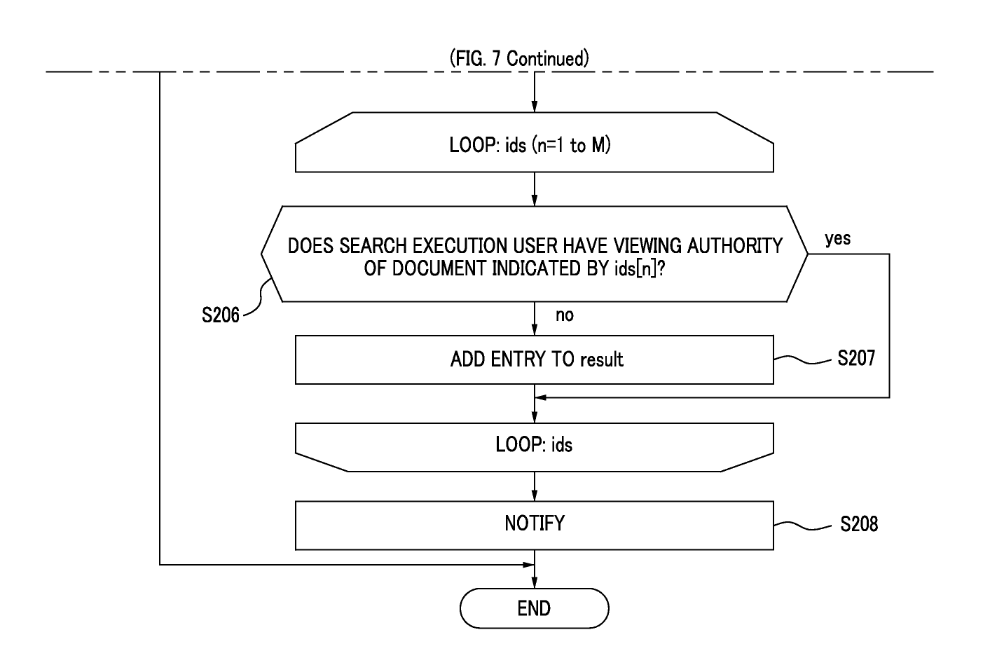

FIG. 7 is a flowchart exemplifying a process performed by the document management apparatus 2 in the second embodiment. The process is performed when one or plural search keywords are input as a search condition by a login user (hereinafter, referred to as a search execution user). In addition, here as well, description of a process performed by the normal search unit 10 is omitted.

First, the microprocessor initializes result data in the same manner as step S101 (refer to FIG. 3) (S201). The result data will be described later.

In addition, the microprocessor (the special search portion 16b) searches for documents satisfying a search condition among the documents stored in the document storage unit 4 (S202). The microprocessor (the second determination portion 34a) determines whether or not any search keyword exists in the dictionary by referring to the dictionary (S203). In addition, if any one of the search keywords exists in the dictionary (no in S203), the microprocessor (the first determination portion 32) determines whether or not any one of document IDs in the search result obtained through the process in step S202 exists in the secret document ID holding unit 30 as a secret document ID (S204). If any one of document IDs in the search result exists in the secret document ID holding unit 30 (yes in S204), a secret document ID group including M (where M≧1) secret document IDs included in the search result is stored in a character string type arrangement ids (S205).

Further, the microprocessor performs steps S206 and S207 for each secret document ID stored in the arrangement ids. In other words, the microprocessor (the authority determination portion 18b) determines whether or not the search execution user has viewing authority of the document by referring to an ACL of the document indicated by ids [n] (S206). If the search execution user does not have viewing authority of the document indicated by ids [n] (no in S206), the microprocessor adds an entry to the result data (S207). In the second embodiment, the entry is data of a map form, holds ids [n] as a key, and holds an email address of a user having view authority of a secret document indicated by ids [n] as a value. In the second embodiment as well, the email address of the user is stored in the result data in a case where leakage of the secret is detected.

In this way, when the processes in steps S206 and S207 are completed with regard to all the secret document IDs stored in the arrangement ids, the microprocessor (the notification unit 20b) transmits a warning electronic mail using the email address included in the entry as a destination if there is the entry in the result data (S208). According to the second embodiment, even if a secret keyword is not registered, leakage of a secret is detected.

### Third Embodiment

Here, it is assumed that a word related to secret information is a coined word made by joining two words existing in a dictionary. In this case, when a user hearing this coined word inputs a search keyword, there is a possibility that the coined word may not be input as a single search keyword but each word forming the coined word may be input depending on users. In this case, leakage of a secret is not detected in the second embodiment. Therefore, in a third embodiment, leakage of a secret may be detected even in this case.

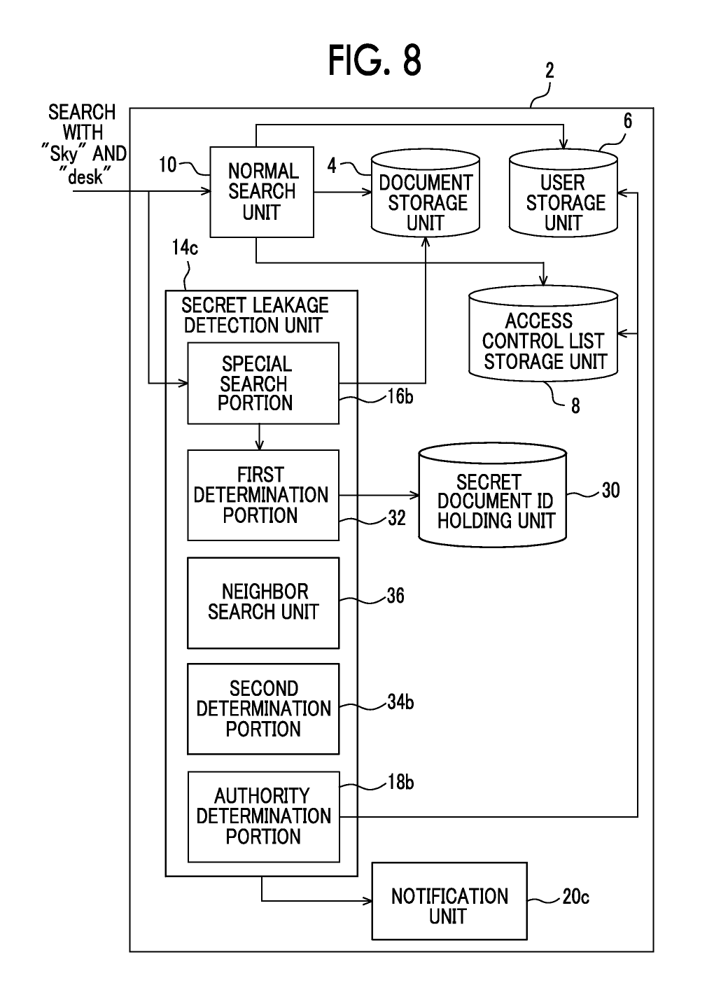

FIG. 8 is a diagram exemplifying a configuration of the document management apparatus 2 according to the third embodiment. In the third embodiment as well, the document management apparatus 2 is realized by a personal computer and a server computer, and includes a document storage unit 4, a user storage unit 6, an ACL storage unit 8, and a normal search unit 10, in the same manner as the second embodiment.

However, in the third embodiment, the dictionary storage unit 26 is omitted. In addition, the document management apparatus 2 includes a secret leakage detection unit 14c instead of the secret leakage detection unit 14b (refer to FIG. 6). In addition, the document management apparatus 2 includes a notification unit 20c instead of the notification unit 20b. The secret leakage detection unit 14c is realized mainly by the microprocessor, and includes a special search portion 16b, a first determination portion 32, and an authority determination portion 18b, in the same manner as the second embodiment. In addition, the secret leakage detection unit 14c includes a second determination portion 34b instead of the second determination portion 34a. In addition, the secret leakage detection unit 14c includes a neighbor search unit 36.

The secret leakage detection unit 14c is common to the secret leakage detection unit 14b in that the special search portion 16b, the first determination portion 32, and the authority determination portion 18b are provided. However, there is a difference from the secret leakage detection unit 14b in that the neighbor search unit 36 and the second determination portion 34b are provided.

The neighbor search unit 36 performs the following processes when plural search keywords are input as a search condition. In other words, the neighbor search unit 36 performs a neighbor search using these search keywords in documents indicated by document IDs in a search result. In addition, the second determination portion 34b determines whether or not a score obtained as a result of the neighbor search is equal to or more than a reference value set in advance. The shorter the distance between the search keywords, the higher the score of the neighbor search.

In addition, if the document ID in the search result of the special search portion 16b is held in the secret document ID holding unit 30 as a secret document ID, the score obtained as a result of the neighbor search is equal to or more than a reference value, and the login user does not have viewing authority of the document indicated by the document ID in the search result, the notification unit 20c performs a warning process. For example, the notification unit 20c transmits a warning electronic mail including a text of notifying that there is a possibility of leakage of the secret.

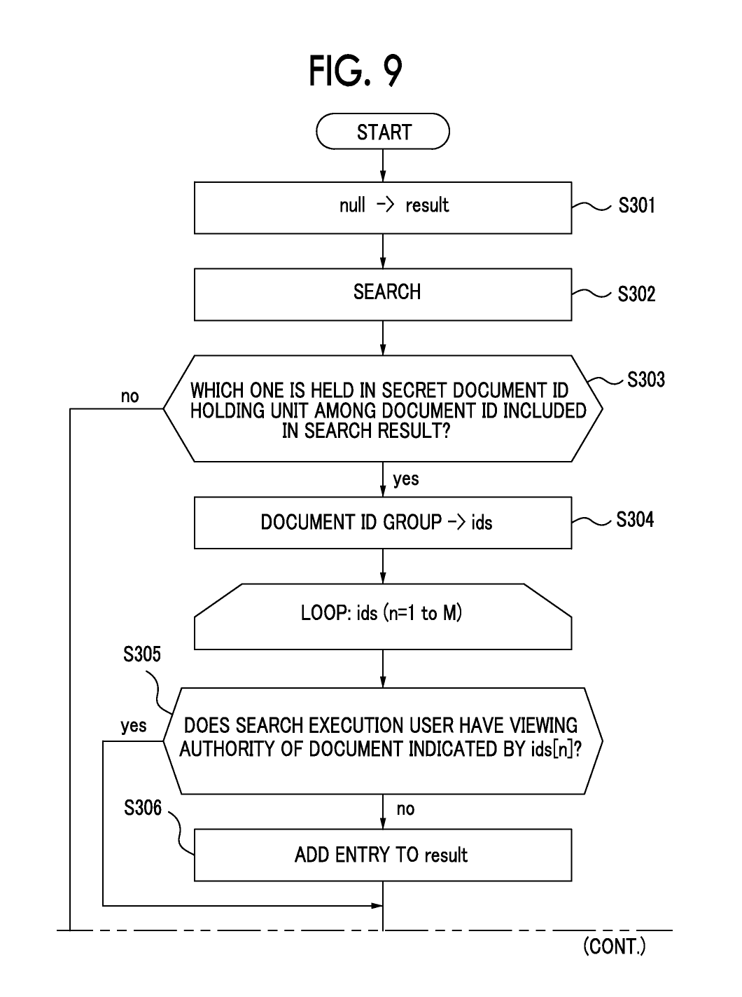

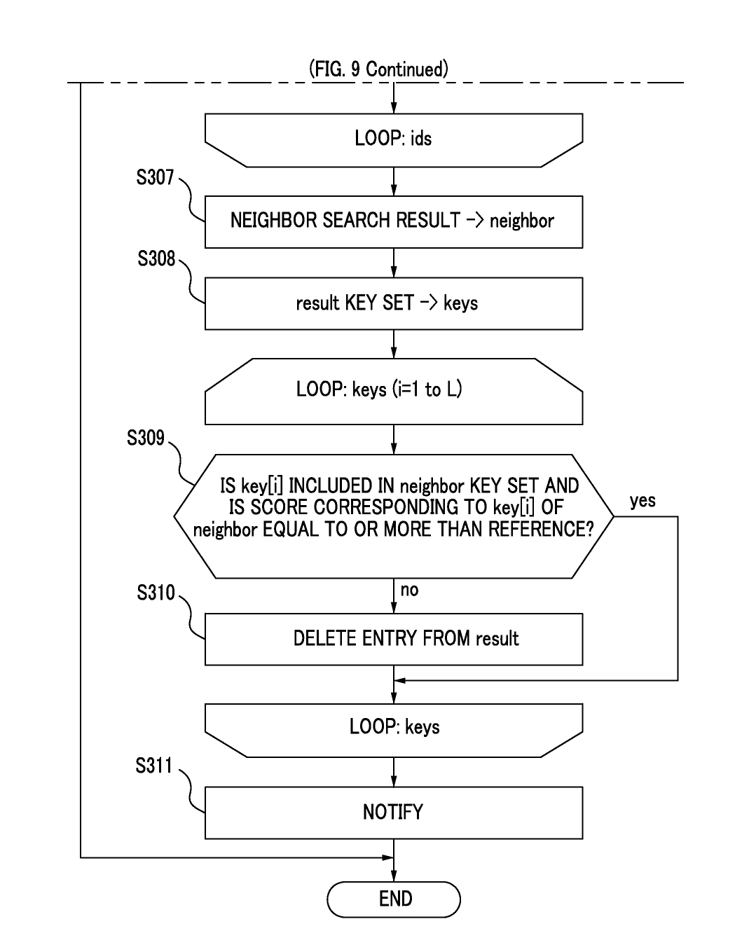

FIG. 9 is a flowchart exemplifying a process performed by the document management apparatus 2 in the third embodiment. The process is performed when “plural” search keywords are input as a search condition by a login user (hereinafter, referred to as a search execution user). In addition, here as well, description of a process performed by the normal search unit 10 is omitted.

First, the microprocessor initializes result data in the same manner as step S201 (refer to FIG. 7) (S301). The result data will be described later.

In addition, the microprocessor (the special search portion 16b) searches for documents satisfying a search condition among the documents stored in the document storage unit 4 in the same manner as step S202 (S302). In addition, in the same manner as step S204, the microprocessor (the first determination portion 32) determines whether or not any one of document IDs in the search result obtained through the process in step S302 exists in the secret document ID holding unit 30 as a secret document ID (S303). If any one of document IDs in the search result exists in the secret document ID holding unit 30 (yes in S303), the microprocessor stores a secret document ID group including M (where M≧1) secret document IDs included in the search result in a character string type arrangement ids (S304), similarly to S205.

Further, the microprocessor performs steps S305 and S306 for each secret document ID stored in the arrangement ids. In other words, the microprocessor (the authority determination portion 18b) determines whether or not the search execution user has viewing authority of the document indicated by ids [n] in the same manner as step S206 (S305). If the search execution user does not have viewing authority of the document indicated by ids [n] (no in S305), the microprocessor adds an entry to the result data (S306). In the third embodiment as well, the entry is data of a map form, holds ids [n] as a key, and holds an email address of a user having view authority of a secret document indicated by ids [n] as a value, in the same manner as the second embodiment.

In this way, when the processes in steps S305 and S306 are completed with regard to all the secret document IDs stored in the arrangement ids, the microprocessor (the neighbor search unit 36) performs a neighbor search using all the search keywords for the documents held in the document storage unit 4, by designating the lowest score. In addition, by using a document ID of a document which obtains a score equal to or more than the lowest score as a key, the microprocessor generates neighbor data which is a map having the score of the document as a value (S307). Further, the microprocessor stores a set of L document IDs which are included in the result data as keys in arrangement keys (S308). Hereinafter, an i-th (where i=1 to L) key is denoted by key [i].

The microprocessor (the second determination portion 34b) performs steps S309 and S310 for each secret document ID stored in the arrangement keys. That is to say, the microprocessor (the second determination portion 34b) determines whether or not key [i] is included in the key set of the neighbor data, and a score of a secret document indicated by key [i] included in the neighbor data is equal to or more than a reference value (S309). If key [i] is included in the key set of the neighbor data, and a score of a secret document indicated by key [i] included in the neighbor data is less than a reference value (no in S309), the microprocessor deletes an entry having key [i] as a key from the result data (S310).

In this way, when the processes in steps S309 and S310 are completed with regard to all the secret document IDs stored in the arrangement keys, the microprocessor (the notification unit 20c) transmits a warning electronic mail using the email address included in the entry as a destination if there is any entry in the result data (S311).

In addition, an embodiment of the invention is not limited to the above-described embodiments.

For example, in the first embodiment, in a case where a search keyword is held in the secret keyword holding unit 12 as a secret keyword, the special search portion 16a (refer to FIG. 1) may search for a document in the same manner as the special search portion 16b (refer to FIG. 6). In this case, only the secret keyword may be held in the secret keyword holding unit 12.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document management apparatus comprising:
a search unit that searches for documents using a search character string which is input as a search condition by a search execution user;
a secret condition success determining unit that determines whether or not the search condition satisfies a predetermined secret condition; and
a warning unit that outputs warning information when the search condition satisfies the secret condition, and the search execution user does not have access authority for the searched document.

2. The document management apparatus according to claim 1, wherein a character string registered as a secret character string is stored in a secret character string memory in advance,
wherein the secret condition success determining unit includes a determining portion that determines whether or not the search character string is stored in the secret character string memory as the secret character string, and
wherein the warning unit outputs warning information when the search character string is stored in the secret character string memory as the secret character string and the search execution user does not have the access authority for the searched document.

3. The document management apparatus according to claim 2, wherein documents related to the secret character string are correlated with the secret character string, and
wherein the search unit sets the documents correlated with the secret character string as a search result when the search character string is stored in the secret character string memory as a secret character string.

4. The document management apparatus according to claim 2, being connected to a network so as to communicate with each other, further comprising:
a public document search unit that searches for public documents published on the network using the secret character string stored in the secret character string memory as a search keyword; and
a deletion unit that deletes the secret character string from the secret character string memory when at least one public document is searched as a result of the search.

5. The document management apparatus according to claim 3, being connected to a network so as to communicate with each other, further comprising:
a public document search unit that searches for public documents published on the network using the secret character string stored in the secret character string memory as a search keyword; and
a deletion unit that deletes the secret character string from the secret character string memory when at least one public document is searched as a result of the search.

6. The document management apparatus according to claim 3, further comprising:
a dictionary memory that stores a dictionary; and
a correlating unit that stores a character string indicating a significant word in the secret character string memory as a secret character string and correlates the character string indicating the significant word with a predetermined document when the significant word which does not exist in the dictionary is included in the predetermined document.

7. The document management apparatus according to claim 1, further comprising:
a dictionary memory that stores a dictionary,
wherein the secret condition success determining unit includes a determining portion that determines whether or not the search character string exists in the dictionary, and
wherein the warning unit outputs warning information when the search character string does not exist in the dictionary and the search execution user does not have the access authority for the searched document.

8. The document management apparatus according to claim 7, wherein a secret document is registered in advance,
wherein the secret condition success determining unit further includes a determining portion that determines whether or not the searched document is registered as the secret document, and
wherein the warning unit outputs warning information when the search character string does not exist in the dictionary, the searched document is registered as the secret document, and the search execution user does not have access authority for the searched document.

9. The document management apparatus according to claim 1, wherein a plurality of search character strings are input as a search condition, and a secret document is registered in advance,
wherein the secret condition success determining unit includes
a determining portion that determines whether or not the searched document is registered as the secret document; and
a neighbor search unit that performs a neighbor search for the plurality of search character strings in the searched document when the searched document is registered as the secret document, and
wherein the warning unit outputs warning information when the searched document is registered as the secret document, an evaluation value obtained as a result of the neighbor search is equal to or more than a reference, and the search execution user does not have the access authority for the searched document.

10. A non-transitory computer readable medium storing a program causing a computer to function as:
a search unit that searches for documents using a search character string which is input as a search condition by a search execution user;
a secret condition success determining unit that determines whether or not the search condition satisfies a predetermined secret condition; and
a warning unit that outputs warning information when the search condition satisfies the secret condition, and the search execution user does not have access authority for the searched document.

11. A document management method comprising:
searching for documents using a search character string which is input as a search condition by a search execution user;
determining whether or not the search condition satisfies a predetermined secret condition; and
outputting warning information when the search condition satisfies the secret condition, and the search execution user does not have access authority for the searched document.
